(19) United States
(12) Patent Application Publication
(10) Pub. No.: US 2020/0126511 A1
(43) Pub. Date: Apr. 23, 2020

(54) A PRESENTATION SYSTEM, AND A METHOD IN RELATION TO THE SYSTEM

(71) Applicant: Cargotec Patenter AB, Ljungby (SE)

(72) Inventor: Per GUSTAFSSON, Hudiksvall (SE)

(21) Appl. No.: 16/603,926

(22) PCT Filed: Apr. 3, 2018
(86) PCT No.: PCT/SE2018/050348

§ 371 Date: Oct. 9, 2019

(30) Foreign Application Priority Data
Apr. 11, 2017 (SE) 1750431-7

(51) Int. Cl. G09G 5/10; B66C 13/16; B66C 13/46; B60R 1/00; B60K 35/00

(52) U.S. Cl. CPC G09G 5/10; B66C 13/16; H04N 13/239; B60R 1/00; B60K 35/00; B66C 13/46

(57) ABSTRACT

A presentation system (2) comprising at least one camera unit (4) configured to capture image data of the environment, and a user presentation unit (6) comprising at least one display unit (8) and being structured to be head-mounted on a user such that said at least one display unit (8) is positioned in front of the eyes of the user, and configured to display, in real time, at least a part of a captured real time image to the user, wherein said displayed part is dependent of the orientation of the user presentation unit (6). The at least one display unit (8) comprises at least two presentation layers (10, 12), said layers include a real time image layer (10) and a digital curtain layer (12), wherein said digital curtain layer (12) is in front of said real time image layer (10) in relation to the user; said presentation system (2) further comprises a control unit (14) configured to receive a digital curtain extension signal (16) comprising extension data, and a digital curtain transparency signal (18) comprising transparency data.The control unit (14) is configured: -to control the extension of a digital curtain (20) in said digital curtain layer (12), in dependence of said extension data, within a range from covering the entire real time image layer (10) to not cover any part of the real time image layer (10), and -to control the transparency of the digital curtain (20) in said digital curtain layer (12), in dependence of said transparency data, within a range from full transparency to non-transparency.

### TECHNICAL FIELD

The present disclosure relates to a presentation system, and a method in relation to the system. In particular the system is adapted to be applied in a vehicle provided with a crane where a camera unit is mounted on the crane in order to assist an operator when operating the crane.

### BACKGROUND

Working vehicles are often provided with various movable cranes, which are attached to the vehicle via a joint. These cranes comprise movable crane parts, e.g. booms, that may be extended, and that are joined together by joints such that the crane parts may be folded together at the vehicle and extended to reach a load. Various tools, e.g. buckets or forks, may be attached to the crane tip, often via a rotator.

An operator has normally visual control of the crane when performing various tasks. A crane provided with extendible booms often has a large working range which sometimes is required in order to reach loads at remote locations. Today an operator is required to visually inspect a position of a load and the load before e.g. lifting it with a fork. This may sometimes be difficult from a remote location, e.g. when the load is positioned at a location which is not easily accessible, and furthermore, the operator needs sometimes inspect the load by walking around it. Furthermore, the loading/unloading procedure may occur in an environments where very limited space is available when lifting a load. Various obstacles, e.g. edges of buildings and other fixed constructions may thus hinder or obstruct the procedure. These obstacles may sometimes be difficult to identify. All these aspect may altogether lengthen a loading or unloading procedure.

In the prior art there are various examples of using camera systems or other image capturing devices in order to support the user. In particular documents related to virtual and augmented reality goggles where various information may be presented to the user. In the following some documents are briefly discussed disclosing various aspects of the technology.

U.S. Pat. No. 9,158,114 relates to an image display utilizing a variable mask to selectively block image data. Wearable display devices, such as augmented reality goggles, may display a combination of two images. In the disclosed apparatus a first image and a second image is combined to a third image. A variable mask is provided to mask various portions of one of the images. The mask may be variable to change from a transmissive state to a non-transmissive state.

US-2017/0010692 relates to a head-mounted augmented reality system and method. As an example, the method includes displaying, on a head mounted display, e.g. goggles, a plurality of display elements, each having an assigned function, in a fixed position relative to real world features viewed via the display.

US-2017/0039905 discloses a display that includes a two-dimensional array of tiles, and specifically a head-mounted display that enhances the user's virtual-reality and/or augmented reality experience.

US-2015/0249821 relates to a device for obtaining surrounding information for a vehicle. At an end portion of a telescopic boom of a crane, a stereo camera which measures a distance from the end portion to an object is provided, and an image-processing controller which obtains three-dimensional position information of the object based on the crane as reference from measurement data to the object by the stereo camera is provided. The three-dimensional position information of an object in a surrounding area centering the crane by the moving of the telescopic boom is obtained.

A drawback when using a display, e.g. a head-mounted display, is that the presented image sometimes includes very bright portions which may dazzle an operator and possibly preventing him/her from having a clear view of an object to be handled.

The object of the present invention is eliminate, or at least reduce, this drawback, and to achieve an improved presentation system that enables an operator of the system to more clearly see an object and/or environment and an object which improves the safety, e.g. in relation to loading or unloading procedures.

### SUMMARY

The above-mentioned object is achieved by the present invention according to the independent claims.

Preferred embodiments are set forth in the dependent claims.

According to a first aspect the invention relates to a presentation system that comprises at least one camera unit configured to capture image data of the environment, and a user presentation unit comprising at least one display unit and being structured to be head-mounted on a user such that said at least one display unit is positioned in front of the eyes of the user. The display unit is configured to display, in real time, at least a part of a captured real time image to the user, and that the displayed part is dependent of the orientation of the user presentation unit. The at least one display unit comprises at least two presentation layers. The layers include a real time image layer and a digital curtain layer, wherein the digital curtain layer is in front of said real time image layer in relation to the user. The presentation system further comprises a control unit configured to receive a digital curtain extension signal comprising extension data, and a digital curtain transparency signal comprising transparency data. Furthermore, the control unit is configured: to control the extension of a digital curtain in the digital curtain layer, in dependence of the extension data, within a range from covering the entire real time image layer to not cover any part of the real time image layer, and to control the transparency of the digital curtain in the digital curtain layer, in dependence of the transparency data, within a range from full transparency to non-transparency. The presentation system is applicable in many different fields, e.g. in the gaming industry, in various sports, and in particular for working vehicles, e.g. forestry vehicles, loading vehicles.

In one embodiment the user presentation unit is a pair of head-mountable virtual reality goggles.

In another embodiment the user presentation unit comprises an orientation sensor configured to sense the orientation of the user presentation unit in three dimensions and to generate an orientation signal including orientation data representing the sensed orientation. This is advantageous in that the digital curtain thereby will remain covering the same part of a real time image during movements of the presentation unit.

In still another embodiment the control unit is configured to automatically control the extension of the digital curtain in dependence of the orientation of user presentation unit. When the user moves the user presentation unit the presented real time image is changed in dependence of the movement, and also the extension of the digital curtain is changed in order to cover the bright parts of the real time image.

In a further embodiment the control unit is configured to automatically control the extension of the digital curtain in dependence of a measured brightness of the captured image, and wherein the digital curtain is controlled to have an extension such that it covers the parts of the captured image having the highest level of brightness. This is beneficial as an automatic adaptation to the light conditions is achieved.

According to another embodiment the digital curtain has an essentially straight lower delimitation, and that the control unit is configured to control the orientation of the lower delimitation such that the delimitation is essentially horizontal irrespectively of the orientation of the user presentation unit.

In still another embodiment the presentation system further comprises at least one input member structured to receive input commands from a user and to generate the digital curtain extension signal and the digital curtain transparency signal in response of input commands by the user. This feature facilitates easy control of the extension and transparency of the digital curtain.

In a further embodiment the control unit is configured to receive input commands regarding the colour of the digital curtain, and to set the colour of the digital curtain in dependence thereto. Thereby the user may adapt the colour of the digital curtain to the light conditions.

According to a second aspect of the present invention the presentation system disclosed herein is applied in a vehicle, e.g. a working vehicle provided with a crane, wherein the camera unit is mounted at the crane of the vehicle, preferably close to a crane tip of said crane.

According to a third aspect of the present invention a method in a presentation system is provided. The presentation system comprises a user presentation unit comprising at least one display unit and being structured to be head-mounted on a user such that said at least one display unit is positioned in front of the eyes of the user. The method comprises:

capturing image data of an environment by at least one camera unit (4), the method further comprises:

displaying, in real time, at least a part of a captured real time image to the user, wherein said displayed part is dependent of the orientation of the user presentation unit.

The at least one display unit comprises at least two presentation layers, said layers include a real time image layer and a digital curtain layer, wherein said digital curtain layer is in front of said real time image layer in relation to the user.

The method further comprises:

receiving, in a control unit, a digital curtain extension signal comprising extension data, and a digital curtain transparency signal comprising transparency data;

controlling the extension of a digital curtain in said digital curtain layer, in dependence of said extension data, within a range from covering the entire real time image layer to not cover any part of the real time image layer, and

controlling the transparency of the digital curtain in said digital curtain layer, in dependence of said transparency data, within a range from full transparency to non-transparency.

In one typical example a virtual reality (VR) goggles, a camera unit, and connectivity are used to develop a system with camera units on top of a forestry crane, which enables the operator to see the working area and operate the crane remotely using VR goggles. In one embodiment there are four cameras located in a small box where the operator's head would normally be to allow a realistic 240-degree view for operator, who controls the crane from the truck cabin.

### BRIEF DESCRIPTION OF THE DRAWINGS

FIG. 1 is a block diagram illustrating various components of the present invention.

FIG. 2 shows schematic illustration of a display unit according to the present invention.

FIG. 3 is a schematic illustration of a presentation unit according to the present invention.

FIG. 4 is a schematic illustration of a vehicle according to the present invention.

FIG. 5 is a flow diagram showing the method steps according to the present invention.

### DETAILED DESCRIPTION

The presentation system, and method, will now be described in detail with references to the appended figures. Throughout the figures the same, or similar, items have the same reference signs. Moreover, the items and the figures are not necessarily to scale, emphasis instead being placed upon illustrating the principles of the invention.

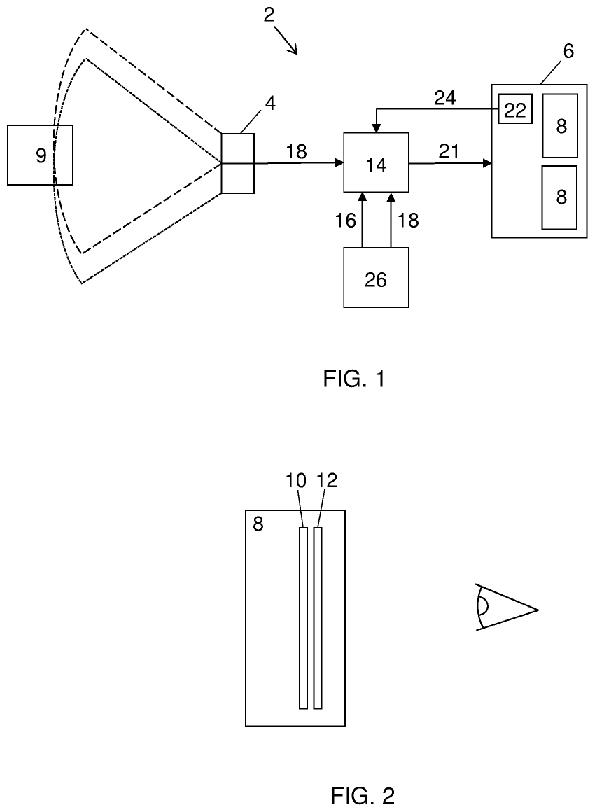

With references to the block diagram shown in FIG. 1 a schematic illustration of a presentation system 2 according to the present invention is shown. The system is preferably intended for use in connection with a vehicle, e.g. a vehicle provided with a crane (see FIG. 4). The presentation system comprises at least one camera unit 4, which advantageously is mounted at the vehicle and is configured to capture image data, e.g. of the vehicle and/or of the environment around the vehicle.

The presentation system further comprises a user presentation unit 6 comprising at least one display unit 8, preferably two display units 8, and being structured to be head-mounted on a user such that the at least one display unit 8 is positioned in front of the eyes of the user, and configured to display, in real time, at least a part of a captured real time image to the user. The displayed part is dependent of the orientation of the user presentation unit 6.

The at least one display unit 8 comprises at least two presentation layers 10, 12 (see FIG. 2). The presentation layers include a real time image layer 10 and a digital curtain layer 12, wherein the digital curtain layer 12 essentially overlaps and is arranged in front of the real time image layer 10 in relation to the user, which is illustrated in the schematic illustration in FIG. 2 where a user's eye is shown to the right.

The presentation system 2 further comprises a control unit 14 configured to receive a digital curtain extension signal 16 comprising extension data, and a digital curtain transparency signal 18 comprising transparency data. The control unit may be a separate unit and it may be embodied as a dedicated electronic control unit (ECU), or implemented as a part of another ECU. As an alternative the control unit may be an integral part of the user presentation unit 6

The control unit 14 is configured to control the extension of a digital curtain 20, in the digital curtain layer 12, in dependence of the extension data, within a range from covering the entire real time image layer 10 to not cover any part of the real time image layer 10, by determining, and applying a control signal 21 to the user presentation unit 6.

The control unit 14 is also configured to control, by the control signal 21, the transparency of the digital curtain 20 in the digital curtain layer 12, in dependence of the transparency data, within a range from full transparency to non-transparency. In an advantageous embodiment the user presentation unit 6 is a pair of virtual reality goggles.

The presentation unit is configured to display images to the user in accordance with data received from the control unit 14. In various embodiments, the presentation unit may comprise a single adjustable display unit or multiple display units (e.g., a display unit for each eye of a user). A display unit is comprised of a display element, one or more integrated microlens arrays, or some combination thereof. The display unit may be flat, cylindrically curved, or have some other shape.

In some embodiments, the display unit includes an array of light emission devices and a corresponding array of emission intensity array. An emission intensity array may be an array of electro-optic pixels, opto-electronic pixels, some other array of devices that dynamically adjust the amount of light transmitted by each device, or some combination thereof. These pixels are placed behind an array of microlenses, and are arranged in groups. Each group of pixels outputs light that is directed by the microlens in front of it to a different place on the retina where light from these groups of pixels are then seamlessly “tiled” to appear as one continuous image. In some embodiments, computer graphics, computational imaging and other techniques are used to pre-distort the image information (e.g., correcting for the brightness variations) sent to the pixel groups so that through the distortions of the system from optics, electronics, electro-optics, and mechanicals, a smooth seamless image appears. In some embodiments, the emission intensity array is an array of liquid crystal based pixels in an LCD (a Liquid Crystal Display). Examples of the light emission devices include: an organic light emitting diode, an active-matrix organic light-emitting diode, a light emitting diode, some type of device capable of being placed in a flexible display, or some combination thereof. The light emission devices include devices that are capable of generating visible light (e.g., red, green, blue, etc.) used for image generation. The emission intensity array is configured to selectively attenuate individual light emission devices, groups of light emission devices, or some combination thereof. Alternatively, when the light emission devices are configured to selectively attenuate individual emission devices and/or groups of light emission devices, the display unit includes an array of such light emission devices without a separate emission intensity array.

The real time image layer and digital curtain image layer may be regarded as virtual image layers, where the digital curtain image layer is shown in front of the real time image layer and having an adjustable transparency enabling objects in the image presented at the real time image layer may readily be seen. The presentation technique where various layers may be controlled to be presented at different levels in a perpendicular direction in relation to the image surface is known from many commonly used presentation programs, e.g. Powerpoint®.

In one embodiment the user presentation unit comprises an orientation sensor 22 configured to sense the orientation of the user presentation unit in three dimensions and to generate an orientation signal 24 including orientation data representing the sensed orientation. The orientation signal 24 is applied to the control unit.

In a typical application the field of view of the camera system is much wider than the image presented at the display units. In some cases up to 360 degrees, i.e. all around, but normally up to 180 degrees. When using a head-mounted presentation unit the operator may access the entire image captured by the camera unit by moving the presentation unit, e.g. by turning the head to the right, the presented image is changed such that the operator will then see the same part of the environment as if he/she was standing at the positon of the camera unit and looked around.

In one embodiment the control unit is configured to automatically control the extension of the digital curtain in dependence of the orientation of user presentation unit. Thus, according to one example, when the operator moves the presentation unit the digital curtain will remain in the same position in relation to the presented real time image; e.g. if an operator wearing the presentation unit is in a position where he/she is looking straight forward, then looks up and then down, the digital curtain will cover a larger part of the display when he/she looks up and a smaller part when he/she looks down.

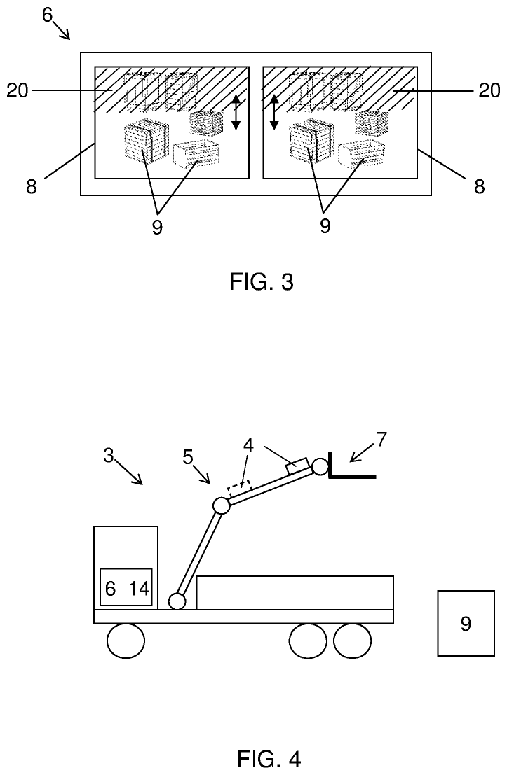

FIG. 3 is a schematic illustration of a user presentation unit 5 provided with two display units 6 as seen by an operator. The display units show essentially the same images, in this this illustrated example a number of boxes, e.g. to be picked up by a fork provided at a crane tip. The operator may consider the presented images too bright, at least in an upper part of the images, e.g. due to sunlight, in order to be able to clearly see the objects. The operator has therefore input control instructions to set the digital curtain 20 at a level where the brightness is lowered and also set a level of transparency such that he/she nevertheless sees the boxes. In the illustrated example the upper third of the images are covered by the digital curtain. The double-arrows indicate that a lower delimitation of the digital curtain may be moved.

The control unit is configured to automatically control the extension of the digital curtain in dependence of a measured brightness of the captured image, and wherein the digital curtain is controlled to have an extension such that it covers the parts of the captured image having the highest level of brightness.

In another embodiment the digital curtain has a straight lower delimitation, and that the control unit is configured to control the orientation of the lower delimitation such that the delimitation is essentially horizontal irrespectively of the orientation of the user presentation unit. In a typical application an upper part of an image presented at the real image presentation layer is brighter than a lower part. Thus, the digital curtain is used to decrease the brightness of the upper part of the image presented to the user in order to enable the user not to be blinded by the light. The delimitation may also be more general and would then delimit the digital curtain irrespectively of the shape and orientation of the digital curtain, i.e. the digital curtain has an extension such that it covers the brighter parts of the presented image.

Advantageously is provided an input member 26 being structured to receive input commands 28 from a user and to generate the digital curtain extension signal 16 and the digital curtain transparency signal 18 in response of input commands by the user. The input member may be one or many buttons, one or many joysticks, or input areas of a touchscreen.

In some light conditions it is favourable to have a coloured digital curtain. A typical colour would be black, grey or brown, but other colours may also be applicable, e.g. yellow, red, or blue. Thus, the control unit 14 is configured to receive input commands regarding the colour of the digital curtain, and to set the colour of the digital curtain in dependence thereto.

In one implementation the presentation system is applied in relation with a vehicle and the camera unit is typically mounted at a crane of the vehicle, preferably close to a crane tip of said crane. The vehicle is any vehicle provided with a crane, or similar, and includes any working vehicle, forestry vehicle, transport vehicle, and loading vehicle. In FIG. 4 is shown a vehicle 3 provided with a presentation system according to the present invention.

The illustrated vehicle 3 comprises a movable crane 5, e.g. a foldable crane, mounted on the vehicle and movably attached to the vehicle. The crane 5 is provided with a tool 7, e.g. a fork or a bucket, attached to a crane tip. The crane 5 comprises at least one crane part, e.g. at least one boom that may be one or many extendible booms, and is movable within a movement range.

The vehicle and the crane will not be disclosed in greater detail as these are conventional, and being conventionally used, e.g. with regard to the joint between the crane and the vehicle, the joints between the crane parts of the crane, and the joint between a crane tip and a tool which normally is a rotator.

The camera unit 4 is preferably mounted at the crane, e.g. close to the crane tip, and is movable together with said crane.

The camera unit 4 comprises at least two cameras arranged at a distance from each other, and preferably two cameras, which have essentially overlapping field of views. The limitations for the field of views for the camera unit are indicated as dashed lines in FIG. 1. The camera unit will be further discussed below. Thus, the camera unit 4 comprises at least two cameras, preferably two cameras, sometimes called a stereo camera. This is an advantageous embodiment as stereo camera systems are more and more frequently used in various vehicles.

A stereo camera is a type of camera with two lenses with a separate image sensor for each lens. This allows the camera to simulate human binocular vision, and therefore gives it the ability to capture three-dimensional images, a process known as stereo photography. Stereo cameras may be used for making 3D pictures, or for range imaging. Unlike most other approaches to depth sensing, such as structured light or time-of-flight measurements, stereo vision is a purely passive technology which also works in bright daylight.

The present invention also comprises a method in a presentation system 2. The presentation system comprises a user presentation unit comprising at least one display unit and being structured to be head-mounted on a user such that said at least one display unit is positioned in front of the eyes of the user. The at least one display unit comprises at least two presentation layers. The layers include a real time image layer and a digital curtain layer, wherein the digital curtain layer is in front of said real time image layer in relation to the user. For further details of the presentation system it is referred to the above description and the figures referred to.

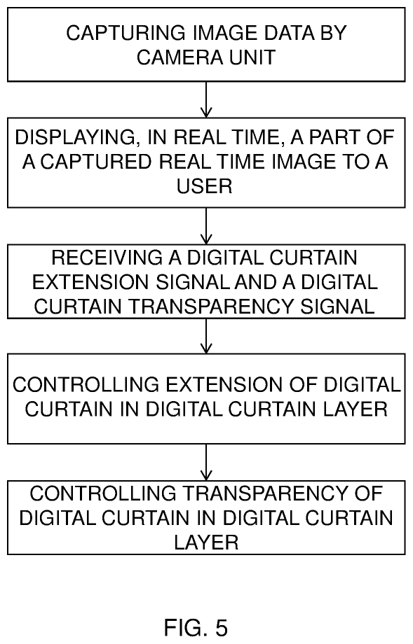

With references to the flow diagram shown in FIG. 5 the method will now be disclosed in greater detail. The method comprises capturing image data of an environment by at least one camera unit 4.

The method further comprises displaying, in real time, at least a part of a captured real time image to the user, wherein the displayed part is dependent of the orientation of the user presentation unit.

The method further comprises:

Receiving, in a control unit, a digital curtain extension signal comprising extension data, and a digital curtain transparency signal comprising transparency data.

Controlling the extension of a digital curtain in the digital curtain layer, in dependence of the extension data, within a range from covering the entire real time image layer to not cover any part of the real time image layer, and controlling the transparency of the digital curtain in the digital curtain layer, in dependence of the transparency data, within a range from full transparency to non-transparency.

The method preferably comprises using a pair of virtual reality goggles as the user presentation unit.

In one exemplary variation the user presentation unit comprises an orientation sensor and the method comprises sensing the orientation of the user presentation unit in three dimensions and generating an orientation signal including orientation data representing the sensed orientation.

In a further variation the method comprises automatically controlling the extension of the digital curtain in dependence of the orientation of user presentation unit.

Additionally the method comprises automatically controlling the extension of the digital curtain in dependence of a measured brightness of the captured image, and controlling an extension such that the digital curtain covers the parts of the captured image having the highest level of brightness.

In addition the method comprises controlling the orientation of the extension of a lower delimitation of the digital curtain such that the delimitation is essentially horizontal irrespectively of the orientation of the user presentation unit.

The present invention is not limited to the above-described preferred embodiments. Various alternatives, modifications and equivalents may be used. Therefore, the above embodiments should not be taken as limiting the scope of the invention, which is defined by the appending claims.

1. A presentation system comprising:
at least one camera unit configured to capture image data of the environment,
a user presentation unit comprising at least one display unit and being structured to be head-mounted on a user such that said at least one display unit is positioned in front of the eyes of the user, and configured to display, in real time, at least a part of a captured real time image to the user, wherein said displayed part is dependent of the orientation of the user presentation unit, wherein said at least one display unit comprises at least two presentation layers, said layers include a real time image layer and a digital curtain layer, wherein said digital curtain layer 4 is in front of said real time image layer in relation to the user; and
a control unit configured to receive a digital curtain extension signal comprising extension data, and a digital curtain transparency signal comprising transparency data, and that said control unit is configured:
to control the extension of a digital curtain in said digital curtain layer, in dependence of said extension data, within a range from covering the entire real time image layer to not cover any part of the real time image layer, and
to control the transparency of the digital curtain in said digital curtain layer, in dependence of said transparency data, within a range from full transparency to non-transparency, and
wherein said user presentation unit comprises an orientation sensor configured to sense the orientation of the user presentation unit in three dimensions and to generate an orientation signal including orientation data representing the sensed orientation, and
wherein the control unit is configured to automatically control the extension of the digital curtain in dependence of the orientation of user presentation unit, such that when the user moves the preservation unit the digital curtain will remain in the same position in relation to the presented real time image.

2. The presentation system according to claim 1, wherein said user presentation unit is a pair of virtual reality goggles.

3-4. (canceled)

5. The presentation system according to claim 1, wherein the control unit is configured to automatically control the extension of the digital curtain in dependence of a measured brightness of the captured image, and wherein the digital curtain is controlled to have an extension such that it covers the parts of the captured image having the highest level of brightness.

6. The presentation system according to claim 1, wherein the digital curtain has a straight lower delimitation, wherein said control unit is configured to control the orientation of said lower delimitation such that said delimitation is essentially horizontal irrespectively of the orientation of the user presentation unit.

7. The presentation system according to claim 1, further comprising at least one input member structured to receive input commands from a user and to generate said digital curtain extension signal and said digital curtain transparency signal in response of input commands by said user.

8. The presentation system according to claim 1, wherein said control unit is configured to receive input commands regarding the colour of the digital curtain, and to set the colour of the digital curtain in dependence thereto.

9. The presentation system according to claim 1, wherein said camera unit comprises a stereo camera with two lenses with a separate image sensor for each lens.

10. A vehicle including a crane and comprising a presentation system according to claim 1, wherein said camera unit is mounted at said crane of the vehicle, preferably close to a crane tip of said crane.

11. A method in a presentation system, the method comprises:
capturing image data of an environment by at least one camera unit, the presentation system comprises a user presentation unit comprising at least one display unit and being structured to be head-mounted on a user such that said at least one display unit is positioned in front of the eyes of the user, the method further comprises:
displaying, in real time, at least a part of a captured real time image to the user, wherein said displayed part is dependent of the orientation of the user presentation unit (6),
wherein said at least one display unit comprises at least two presentation layers, said layers include a real time image layer and a digital curtain layer, wherein said digital curtain layer is in front of said real time image layer in relation to the user; and
wherein said method further comprises:
receiving, in a control unit, a digital curtain extension signal comprising extension data, and a digital curtain transparency signal comprising transparency data;
controlling the extension of a digital curtain in said digital curtain layer in dependence of said extension data, within a range from covering the entire real time image layer to not cover any part of the real time image layer, and
controlling the transparency of the digital curtain in said digital curtain layer, in dependence of said transparency data, within a range from full transparency to non-transparency,
sensing the orientation of she user presentation unit in three dimensions:
generating an orientation signal including orientation data representing the sensed orientation, and
automatically controlling the extension of the digital curtain in dependence of the orientation of user presentation unit, such that when the user moves the presentation unit the digital curtain wilt remain in the same position in relation to the presented real time image.
